(19) United States
(12) Patent Application Publication
(10) Pub. No.: US 2021/0354485 A1
(43) Pub. Date: Nov. 18, 2021

(54) ROLL SUPPORT STRUCTURE AND PRINTER

(71) Applicant: TOSHIBA TEC KABUSHIKI KAISHA, Tokyo (JP)

(72) Inventors: Tsuyoshi Sanada, Susono Shizuoka (JP); Yuji Kawamorita, Mishima Shizuoka (JP)

(21) Appl. No.: 17/134,640

(22) Filed: Dec. 28, 2020

(30) Foreign Application Priority Data
May 13, 2020 (JP) 2020-084263

(51) Int. Cl. B41J 15/04; B65H 16/06; B65H 16/10

(52) U.S. Cl. CPC B41J 15/042; B41J 15/046; B65H 2801/12; B65H 16/10; B65H 16/06

(57) ABSTRACT

A roll support structure is used in a printer which pulls out a sheet material from a roll on which the strip-shaped sheet material is wound and performs printing on the sheet material, where a holding portion which is inserted inside a tubular core of the roll to hold the roll rotatably includes a first portion which is in contact with an upper portion of an inner surface of the core and supports the roll from below and a second portion which is located further on a downstream side in a conveyance direction of the sheet material than a contact point between the first portion and the core and prevents movement of the oscillating roll supported by the first portion to the upstream side in a conveyance direction within a predetermined range.

### CROSS-REFERENCE TO RELATED APPLICATION

This application is based upon and claims the benefit of priority from Japanese Patent Application No. 2020-084263, filed on May 13, 2020, the entire contents of which are incorporated herein by reference.

### FIELD

Embodiments described herein relate generally to roll support structures and printers.

### BACKGROUND

A printer which prints on a label performs printing while pulling out the label from a label roll stored inside. The label roll includes a strip-shaped pasteboard on which labels of a predetermined size are attached side by side and a strip-shaped label wrapped without a pasteboard (pasteboard-less label roll). In the pasteboard-less label roll, the glue on a back surface of a label is in contact with a printed surface of a label on the next layer, so a force to peel off the glue is required when pulling out the label. Therefore, label conveyance of the pasteboard-less label roll requires stronger conveyance force than that of a label roll with a pasteboard.

A glue layer of the pasteboard-less label roll is formed by applying an adhesive to the back surface of the label. Types of adhesives include, for example, an emulsion type and a hot melt type. The hot melt type tends to have stronger adhesive strength than the emulsion type and the force required for peeling tends to be greater.

For example, in a printer which prints while conveys a label by interposing the label between a thermal head and a platen roller, when the label is pulled out from the pasteboard-less label roll, if the conveyance force is insufficient for a required peeling force, inconveniences such as printing defects in which the print is crushed in a conveyance direction may occur.

### DESCRIPTION OF THE DRAWINGS

FIG. 1 is a perspective view illustrating an appearance of a printer device of an embodiment as viewed from a front side;

FIG. 2 is a diagram illustrating a state in which an upper cover of the printer device is opened;

FIG. 3 is a diagram schematically illustrating a support structure of a pasteboard-less label roll and a label conveyance path;

FIG. 4 is a perspective view illustrating an appearance of an accommodation portion;

FIG. 5 is a perspective view illustrating an appearance of a guide portion and a holding portion; and

FIG. 6 is a diagram illustrating behavior of the pasteboard-less label roll.

### DETAILED DESCRIPTION

An advantage provided by an embodiment is to provide a configuration capable of preventing conveyance defects caused by peeling of a label when a pasteboard-less label roll is used and maintaining good print quality.

A roll support structure of the embodiment is used in a printer which pulls out a sheet material from a roll on which the strip-shaped sheet material is wound and performs printing on the sheet material, where a holding portion which is inserted inside a tubular core of the roll to hold the roll rotatably includes a first portion which is in contact with an upper portion of an inner surface of the core and supports the roll from below and a second portion which is located further on a downstream side in a conveyance direction of the sheet material than a contact point between the first portion and the core and prevents movement of the oscillating roll supported by the first portion to the upstream side in a conveyance direction within a predetermined range.

### Embodiment 1

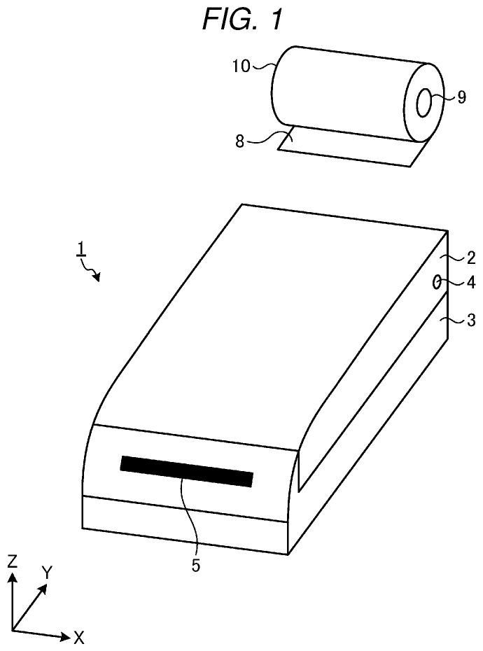

A first embodiment will be described with reference to the drawings. FIG. 1 is a perspective view illustrating an appearance of a printer device 1 according to the first embodiment as viewed from a front side. In the following description, a Cartesian coordinate system composed of the X-axis, the Y-axis, and the Z-axis is used. In the drawings, the direction indicated by the arrow is the positive direction. The X-axis direction is a left-right direction. The positive direction of the Y-axis is a depth direction (rear side of the printer device 1) and the negative direction of the Y-axis is a front direction (front side of the printer device 1). The positive direction of the Z-axis is an upward direction and the negative direction of the Z-axis is a downward direction. The front is a side where a user is located.

The printer device 1 includes an upper cover 2, a lower cover 3, a hinge 4, and an outlet port 5. The printer device 1 internally accommodates a roll 10 in which a strip-shaped sheet material 8 is wound around a cylindrical winding core 9 and prints on the roll 10. A specific example of the sheet material 8 is paper. Since the sheet material 8 receives printing, the sheet material 8 is also called a printing medium or a recording medium.

The printer device 1 prints and issues a receipt or a label, for example. The roll 10 is, for example, a receipt roll, a label roll, or a pasteboard-less label roll. The sheet material 8 forming the receipt roll is paper and the paper is subjected to be printed and issued as a receipt. The sheet material 8 of the label roll is a strip-shaped pasteboard with a label attached and wound. The label includes a glue layer provided on a back surface of paper or the like. The sheet material 8 of the pasteboard-less label roll is a strip-shaped label.

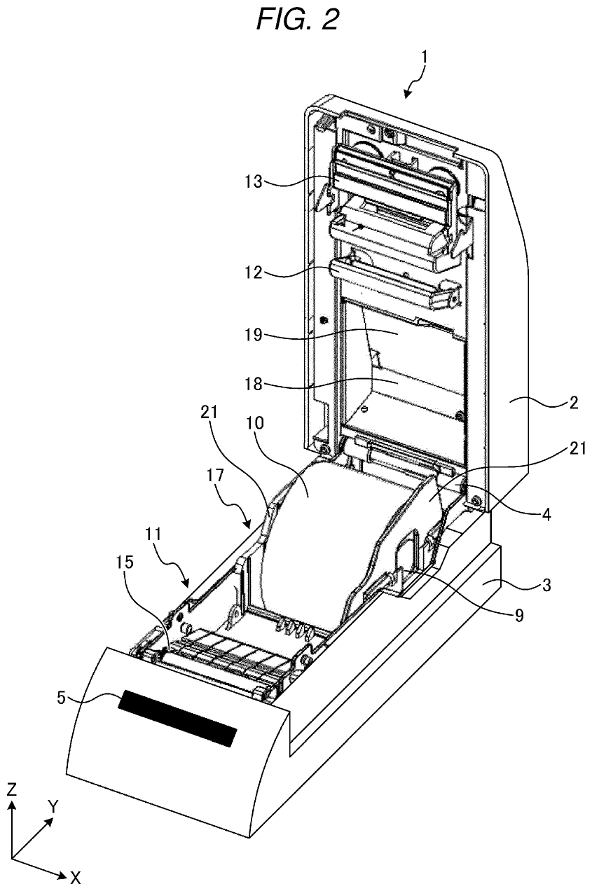

FIG. 2 is a diagram illustrating a state in which the upper cover 2 of the printer device 1 is opened. The printer device 1 includes a printer main body 11, a thermal head 13, a platen roller 15, and an accommodation portion 17. As illustrated in FIGS. 1 and 2, the lower cover 3 and the upper cover 2 cover the printer main body 11 and the accommodation portion 17.

The lower cover 3 is a rectangular parallelepiped container whose upper surface is open and can be opened or closed by the upper cover 2. The lower cover 3 is provided with a connection terminal (not illustrated) used for connecting the internal printer main body 11 and an external device, a power supply terminal (not illustrated) for supplying power to the printer main body 11, and the like.

The outlet port 5 is provided on a front surface of the lower cover 3. The outlet port 5 is opened in a horizontal direction to discharge the sheet material 8 in front of the printer device 1. The appearance illustrated in FIG. 1 is only an example and various modifications are possible.

The hinge 4 is located on a back side of the upper cover 2 and the lower cover 3 and attaches the upper cover 2 to the lower cover 3 to be pivotable about the X-axis direction as a rotation axis. The upper cover 2 opens or closes the opening on an upper surface of the lower cover 3 as the upper cover 2 pivots with respect to the rotation axis.

The thermal head 13 is an example of a print head. The thermal head 13 is fixed to, for example, the inner surface of the upper cover 2. The thermal head 13 comes into close contact with the platen roller 15 in a state where the opening on the upper surface of the lower cover 3 is closed by the upper cover 2. The thermal head 13 includes a plurality of heating elements provided in parallel. The thermal head 13 prints on the paper interposed between the thermal head 13 and the platen roller 15 due to the heat of the heating elements.

The platen roller 15 rotates by transmitting a driving force of a stepping motor (not illustrated) to convey the paper interposed between the platen roller 15 and the thermal head 13. The thermal head 13 and the platen roller 15 forma printing unit.

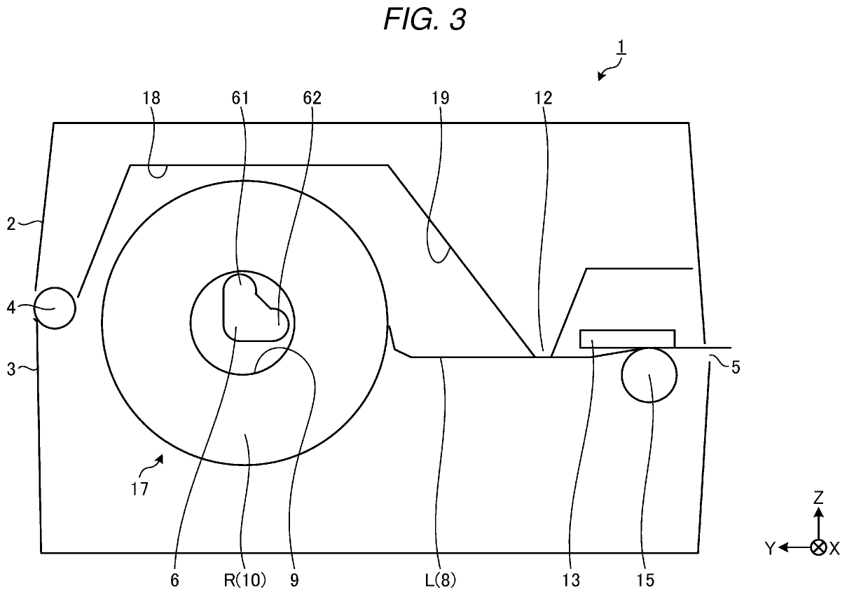

FIG. 3 is a diagram schematically illustrating a support structure of a pasteboard-less label roll R and a conveyance path of a label L. Here, the pasteboard-less label roll R is a kind of the roll 10 and the label L is a kind of the sheet material 8. A conveyance direction in FIG. 3 is from left to right in the drawing.

The pasteboard-less label roll R is accommodated in the accommodation portion 17 so that, the printed surface of the label L to be pulled out faces upward and the glue layer thereof faces downward. The accommodation portion 17 includes a pair of left and right holding portions 6. The holding portions 6 are inserted from both the left and right sides of the winding core 9 to rotatably hook and hold the roll 10.

The upper cover 2 is provided with a pressing portion 12 on the inside (the side facing the lower cover 3). The pressing portion 12 is a portion protruding from the inside of the upper cover 2 and presses the sheet material 8 (label L) pulled out from the roll 10 (pasteboard-less label roll R in FIG. 3) further on an upstream side in the conveyance direction than the thermal head 13.

The upper cover 2 includes an oscillation allowance portion 19 on the inner surface thereof. A portion 18 of the inner surface of the upper cover 2, which is the portion facing the bottom of the accommodation portion 17, covers an upper part of an outer peripheral surface of the roll 10 and a part of the portion 18, which is the portion further on the downstream in the conveyance direction, is the oscillation allowance portion 19. The oscillation allowance portion 19 is provided at a position separated from the outer peripheral surface of the roll 10 having the maximum diameter by a predetermined distance. As a result, the oscillation of the roll 10 having the maximum diameter is acceptable within a predetermined range.

The label L drawn out from the pasteboard-less label roll R is interposed between the thermal head 13 and the platen roller 15 and is conveyed by the rotation of the platen roller 15. As the label L is conveyed, the label L is peeled off from the pasteboard-less label roll R. In order to help the peeling and prevent printing defects due to poor conveyance, in the printer device 1 of the embodiment, the pasteboard-less label roll R suspended from the holding portion 6 is configured to oscillate in a front-rear direction (Y-axis direction). The range of the oscillation is large on the downstream side (front side) in the conveyance direction and small on the rear side. The configuration will be described below.

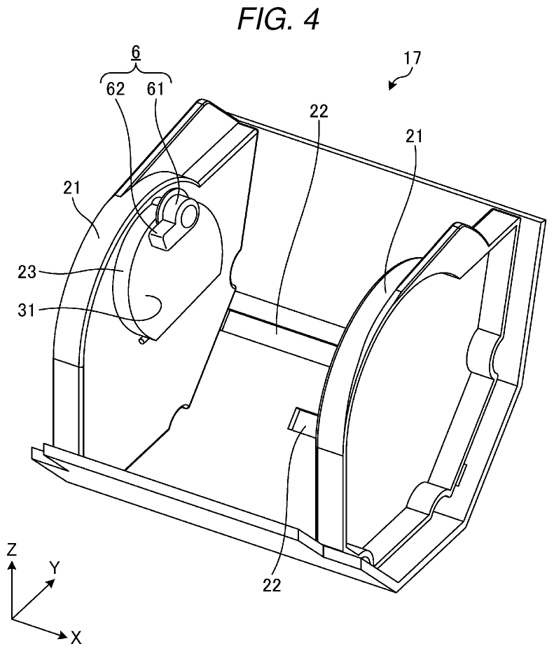

FIG. 4 is a perspective view illustrating an appearance of the accommodation portion 17. The accommodation portion 17 is a container with a top opening for accommodating and holding the roll 10. The accommodation portion 17 includes a pair of guide portions 21 and a rack and pinion.

The pair of guide portions 21 are members that form the side walls of the accommodation portion 17. The pair of guide portions 21 are arranged to face the side ends of the roll 10 around which the strip-shaped sheet material 8 is wound. The pair of guide portions 21 can be moved in a direction in which the pair of guide portions 21 are close to each other or separated from each other by a rack and pinion. The rack and pinion is composed of a pair of rack gears 22 and a pinion gear which meshes with the pair of rack gears 22. The pair of rack gears 22 are parallel to each other and face the tooth surfaces. The pair of guide portions 21 interpose the roll 10 from both side ends to prevent the roll 10 from moving in the width direction (X-axis direction). The roll 10 is aligned with reference to the center in a width direction by a pair of guide portions 21 which symmetrically move along the X-axis direction by the rack and pinion.

The guide portion 21 is provided with a protruding portion 23 projecting toward the other guide portion 21 arranged to face each other. The protruding portion 23 has a guide surface 31. The guide surface 31 is a surface which restricts the movement of the sheet material 8 along the width direction of the sheet material 8 when the sheet material 8 is sent out. The holding portion 6 is provided on the protruding portion 23.

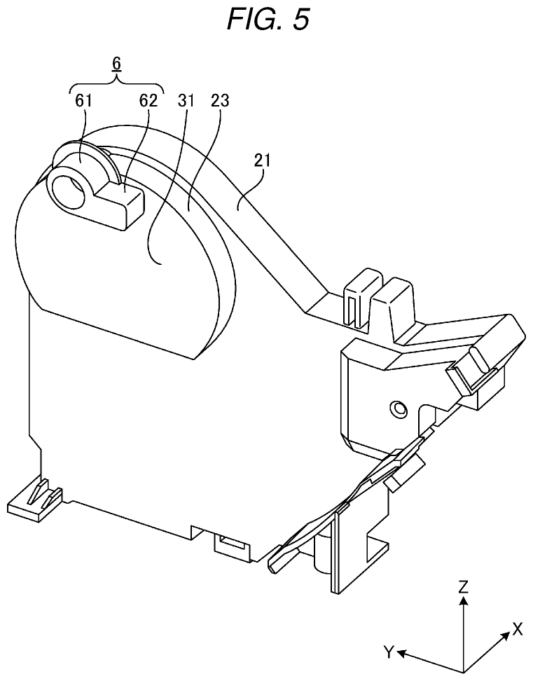

FIG. 5 is a perspective view illustrating appearances of the guide portion 21 and the holding portion 6. The holding portion 6 includes a support portion 61 which is an example of a first portion and a stopper 62 which is an example of a second portion.

The support portion 61 has a cylindrical outer peripheral surface with an axial direction along the X-axis direction and the outer peripheral surface supports the upper lateral-side end portion of the inner peripheral surface of the winding core 9 from below. The support portion 61 is smaller than the inner diameter of the winding core 9 of the roll 10 and the roll 10 is freely rotatable with respect to the support portion 61. The support portion 61 is provided to be in contact with the winding core 9 at a position higher than the platen roller 15 (position where the value of the Z axis is large). Such a positional relationship in which the sheet material 8 is pulled out downward is more likely to cause the roll 10 to oscillate than in the case of the reverse positional relationship (that is, the position of the platen roller 15 is higher than that of the support portion 61).

The stopper 62 is a portion which prevents the roll 10 from oscillating backward and is provided to protrude from the outer peripheral surface of the support portion 61 to the downstream side (Y-axis negative direction) in the conveyance direction. The stopper 62 is located at a position close to the inner peripheral surface of the winding core 9 with a predetermined gap therebetween.

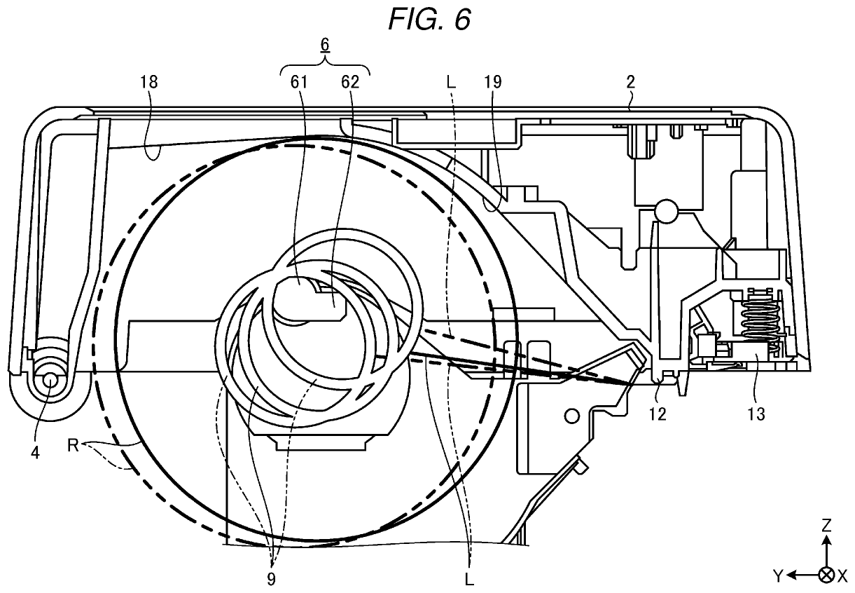

FIG. 6 is a diagram illustrating behavior of the pasteboard-less label roll R. The pasteboard-less label roll R rotates around the holding portion 6 as the label L is conveyed. The label L is conveyed while being peeled off from the surface layer of the pasteboard-less label roll R.

The peeling of the label L and the rotation of the pasteboard-less label roll R do not always result in smooth and stable operation without delay such as the cases of the label roll with a pasteboard and the receipt roll and intermittent operations may occur in which the rotation speed and peeling position are not stable. The unstableness occurs because the glue on the back surface of the label L is attached to the printed surface of the label L on the next layer and is peeled off during conveyance.

If the force required for peeling exceeds the conveyance force of the platen roller 15, the sheet material 8 interposed between the platen roller 15 and the thermal head 13 is not conveyed as controlled. Nevertheless, if the thermal head 13 performs printing while not being conveyed as controlled, the conveyance distance is insufficient, so that the print is crushed in the conveyance direction (printing is clogged). Even when a motor which rotationally drives the platen roller does not step out, print crushing may occur due to deformation of rubber on the surface layer of the platen roller 15.

In order to prevent the occurrence of the above-described inconvenience that the print quality deteriorates, the printer device 1 of the embodiment is configured so that the pasteboard-less label roll R oscillates as the label L is conveyed. As a result, the force required for peeling the label L from the surface layer of the pasteboard-less label roll R is reduced.

In such a printer device 1, the pasteboard-less label roll R suspended from the holding portion 6 first moves to the downstream side in the conveyance direction by being pulled by the adhesive force of the glue on the back surface of the label L as the label L is conveyed (outbound route). In the outbound route, the outer peripheral surface of the pasteboard-less label roll R moves to approach the oscillation allowance portion 19.

Next, the pasteboard-less label roll R suspended from the holding portion 6 moves to the upstream side in the conveyance direction by being pulled by the weight of the pasteboard-less label roll R itself (return route). In the return route, when the inner peripheral surface of the winding core 9 moves to a position where the winding core 9 abuts against the stopper 62, the movement of the pasteboard-less label roll R further upstream in the conveyance direction is prevented.

The pasteboard-less label roll R oscillates by repeating the outbound movement due to the pulling force and the return movement due to the weight of the pasteboard-less label roll R itself due to the above-described conveyance of the label L. Along with the oscillation, the peeling of the label L from the surface layer of the pasteboard-less label roll R is promoted. If the pasteboard-less label roll R does not oscillate, a high peeling force is required at once at the start of conveyance by the platen roller 15. On the other hand, if the pasteboard-less label roll R oscillates as in the embodiment, the oscillating effect acts like a damper that alleviates a sudden increase in the required conveyance force.

Once the label L is peeled off, the adhesive strength is weakened, so even if the label L is reattached to the surface layer of the pasteboard-less label roll R, it is easier to peel off than when the label L has never been peeled off. If moved too far upstream in the conveyance direction during the return movement, there may be a problem that the recoil at the time of the next peeling becomes stronger. However, in the embodiment, since the stopper 62 stops the return movement from being excessive, the above-described inconvenience can be prevented.

As described above, it is possible to avoid a situation in which the conveyance force of the platen roller 15 is insufficient, and thus a conveyance defect of the label L is less likely to occur and it is possible to maintain good print quality.

In the embodiment, the case where the roll 10 is a pasteboard-less label roll R has been described in detail. However, even with other types (for example, a receipt roll and a label roll with a pasteboard), there is no inconvenience in printing with the printer device 1 using the holding portion 6 of the embodiment.

In the embodiment, the printer device 1 aligns the roll 10 with reference to the center in the width direction, but in practice, the printer device 1 may align the roll 10 with reference to either the left or right end (one-sided alignment).

In the embodiment, the holding portion 6 in which the support portion 61 and the stopper 62 are integrated is adopted, but in practice, the support portion 61 and the stopper 62 may be separate bodies.

The stopper 62 is suitable when at least the surface layer portion is made of an elastic material, as the elastic material can cushion the impact when the inner diameter of the roll 10 which moves to the downstream side in the conveyance direction and then returns to the upstream side collides. Since the support portion 61 slides with the inner diameter of the rotating roll 10, it is preferable that the support portion 61 is made of a slippery material such as a mold. The stopper 62 has no inconvenience even if the stopper 62 is not a slippery material. As described above, it is not necessary to uniformly form the support portion 61 and the stopper 62 with the same material.

While certain embodiments have been described, these embodiments have been presented by way of example only, and are not intended to limit the scope of the disclosures. Indeed, the novel embodiments described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A roll support structure for a printer which pulls out a sheet material from a roll on which the sheet material is wound and prints thereon, comprising:
a holding portion insertable inside a tubular core of the roll, the holding portion configured to hold the roll rotatably, the holding portion comprises:
a first portion configured to contact an upper portion of an inner surface of the core and support the roll from below, and
a second portion located further on a downstream side in a conveyance direction of the sheet material with respect to a contact point between the first portion and the core, the second portion configured to prevent oscillating movement of the roll supported by the first portion to the upstream side in the conveyance direction within a predetermined range.

2. The roll support structure according to claim 1, wherein
the first portion is arranged so that the contact point with the core is located at a position higher than a position where printing of the printer is performed.

3. The roll support structure according to claim 1, wherein
the second portion faces the inner surface of the core with a predetermined gap.

4. The roll support structure according to claim 1, further comprising:
a hopper-shaped accommodation portion for accommodating the roll held by the holding portion; and
a cover facing a bottom portion of the accommodation portion and covering the accommodation portion, wherein
in at least on a downstream side of an inner surface of the cover in the conveyance direction, the cover comprises an oscillation allowance portion which is opposed to an outer peripheral surface of the roll having a maximum diameter by a predetermined distance thereby allowing the roll to oscillate downstream in the conveyance direction.

5. The roll support structure according to claim 4, wherein the cover has a rectangular parallelepiped shape.

6. The roll support structure according to claim 1, wherein the sheet material is a strip-shaped sheet material.

7. The roll support structure according to claim 1, wherein the roll is at least one or more of a receipt roll, a label roll, or a pasteboard-less label roll.

8. The roll support structure according to claim 1, wherein the sheet material comprises a label.

9. A printer device, comprising:
a holding portion comprising a first portion in contact with an upper portion of an inner surface of a tubular core of a roll on which a strip-shaped sheet material is wound and supports the roll from below and a second portion located further on a downstream side in a conveyance direction of the sheet material than a contact point between the first portion and the core and prevents oscillating movement of the roll supported by the first portion to the upstream side in a conveyance direction within a predetermined range and inserts inside the core to hold the roll rotatably;
a print head that prints on the sheet material pulled out from the roll held by the holding portion; and
a platen roller that conveys the sheet material by interposing the sheet material with the print head and rotating.

10. The printer device according to claim 9, wherein
the first portion is arranged so that the contact point with the core is located at a position higher than a position where printing of the printer is performed.

11. The printer device according to claim 9, wherein
the second portion faces the inner surface of the core with a predetermined gap.

12. The printer device according to claim 9, further comprising:
a hopper-shaped accommodation portion for accommodating the roll held by the holding portion; and
a cover facing a bottom portion of the accommodation portion and covering the accommodation portion, wherein
in at least on a downstream side of an inner surface of the cover in the conveyance direction, the cover comprises an oscillation allowance portion which is opposed to an outer peripheral surface of the roll having a maximum diameter by a predetermined distance thereby allowing the roll to oscillate downstream in the conveyance direction.

13. The printer device according to claim 12, wherein the cover has a rectangular parallelepiped shape.

14. The printer device according to claim 9, wherein the sheet material is a strip-shaped sheet material.

15. The printer device according to claim 9, wherein the roll is at least one or more of a receipt roll, a label roll, or a pasteboard-less label roll.

16. The printer device according to claim 9, wherein the sheet material comprises a label.

17. A thermal printer, comprising:
a holding portion comprising a first portion in contact with an upper portion of an inner surface of a tubular core of a roll on which a strip-shaped sheet material is wound and supports the roll from below and a second portion located further on a downstream side in a conveyance direction of the sheet material than a contact point between the first portion and the core and prevents oscillating movement of the roll supported by the first portion to the upstream side in a conveyance direction within a predetermined range and inserts inside the core to hold the roll rotatably;
a thermal print head that prints on the sheet material pulled out from the roll held by the holding portion; and
a platen roller that conveys the sheet material by interposing the sheet material with the thermal print head and rotating.

18. The thermal printer according to claim 17, wherein
the first portion is arranged so that the contact point with the core is located at a position higher than a position where printing of the printer is performed.

19. The thermal printer according to claim 17, wherein
the second portion faces the inner surface of the core with a predetermined gap.

20. The thermal printer according to claim 17, further comprising:
a hopper-shaped accommodation portion for accommodating the roll held by the holding portion; and
a cover facing a bottom portion of the accommodation portion and covering the accommodation portion, wherein
in at least on a downstream side of an inner surface of the cover in the conveyance direction, the cover comprises an oscillation allowance portion which is opposed to an outer peripheral surface of the roll having a maximum diameter by a predetermined distance thereby allowing the roll to oscillate downstream in the conveyance direction.
